(19) United States
(12) Patent Application Publication
(10) Pub. No.: US 2025/0369496 A1
(43) Pub. Date: Dec. 4, 2025

(54) BRAKE DISC FOR DISC BRAKES AND METHOD FOR MAKING SUCH A DISC BRAKE

(71) Applicant: Brembo S.p.A., Curno, Bergamo (IT)

(72) Inventors: Andrea MILANESI, Curno, Bergamo (IT); Fabio MELDINI, Curno, Bergamo (IT); Alessandro MANCINI, Curno, Bergamo (IT)

(21) Appl. No.: 18/870,172

(22) PCT Filed: May 26, 2023
(86) PCT No.: PCT/IB2023/055406

§ 371 Date: Nov. 27, 2024

(30) Foreign Application Priority Data
Jun. 1, 2022 (IT) 102022000011636

(51) Int. Cl. F16D 69/02; F16D 65/12; F16D 69/00

(52) U.S. Cl. CPC F16D 69/027; F16D 65/123; F16D 65/125; F16D 65/127; F16D 2069/005; F16D 2200/0013; F16D 2200/0021; F16D 2250/0046

(57) ABSTRACT

The present invention relates to a brake disc for a disc brake, in particular for motor-cycles or motor vehicles, comprising braking band (2), provided with two opposite braking surfaces (2a, 2b), each of which at least partially defines one of the two main faces of the disc (1), the braking band (2) being made of grey cast iron or steel, preferably stainless steel, said disc comprising a surface coating (3) covering at least one of the two braking surfaces of the braking band. Said surface coating (3) is based on a mixture of one or more aluminium oxides and one or more titanium oxides, said surface coating (3) having a darker colour than the steel or grey cast iron of the braking band (2).

### FIELD OF APPLICATION

The present invention relates to a brake disc for disc brakes and to a method for making such a brake disc.

### BACKGROUND ART

A brake disc of a disc braking system of a vehicle or motorcycle comprises an annular structure or braking band. Generally, the brake disc is provided with a central fixing element, known as the bell, by means of which the disc is fixed to the rotating part of a suspension of a vehicle or motorcycle, e.g., a hub. Brake disc solutions can be provided, in which the braking band is fixed directly onto the rotating part of the suspension, e.g., a hub or wheel rim, without the interposition of a bell. The braking band is provided with opposing braking surfaces adapted to cooperate with friction elements (brake pads), housed in at least one calliper body placed straddling such a braking band and integral with a non-rotating component of the vehicle suspension. The controlled interaction between the opposite brake pads and the opposite braking surfaces of the braking band results in braking action by friction which allows the deceleration or stopping of the vehicle.

In many cases, especially in motorcycles, but also in motor vehicles provided with rims with large windows and/or large diameter, the brake disc is clearly visible from the outside of the vehicle, so as to increasingly take an aesthetic value for the users.

Generally, the most common brake discs are made of grey cast iron or steel, in particular stainless steel. Indeed, these materials allow obtaining good braking performance (especially in terms of wear limitation) at a relatively low cost. Discs made of carbon alone or carbon ceramic materials offer much greater performance but at a much higher cost.

The market has also recently seen a growing need to aesthetically characterize grey cast iron or steel brake discs, in order to meet the demands of an increasingly wide range of users.

There is an increasingly popular need among users, in particular of motorcycles, to install brake discs made of grey cast iron or steel, particularly stainless steel, with a braking band having a black or blackish or otherwise darker colour than the starting substrate.

Disc manufacturers have attempted to meet such a need by coating the braking bands with black or blackish-coloured coatings.

However, a coating that allows obtaining a black or blackish or otherwise darker colour than the starting substrate of the braking band while being resistant to high temperatures, wear, abrasion, and corrosion has not yet been identified until now.

In other words, until now, no coating has been found that can be applied to the braking band of brake disc made of grey cast iron or stainless steel which will give it a black or blackish or otherwise darker colour than the starting substrate and will withstand the normal operating conditions of the disc over time.

The only brake discs having black or blackish or otherwise darker colour than the starting substrate which ensure the stability of colour and performance are discs made of carbon alone or carbon ceramic materials.

However, such discs have much higher costs than grey cast iron or steel discs.

In the field of brake discs, in particular for motorcycles, the need is strongly felt to make brake discs having a braking band made of grey cast iron or steel, in particular stainless steel, provided with a coating having a black or blackish or otherwise darker colour than the starting substrate and which can withstand the normal operating conditions to which the disc is subjected over time.

### OVERVIEW OF THE INVENTION

It is the object of the present invention to provide a brake disc for disc brakes made of grey cast iron or steel, in particular for motor vehicles or motorcycles, which has a braking band with a black or blackish or otherwise darker colour than the starting substrate and which can withstand the normal operating conditions to which the brake disc is subjected over time.

Such drawbacks are solved by a brake disc made of grey cast iron or steel according to claim 1 and by a method for making such a brake disc according to claim 17.

Other embodiments of the disc brake and of the making method according to the invention are described in the following claims.

### DESCRIPTION OF THE DRAWINGS

Further features and advantages of the present invention will be more comprehensible from the following description of preferred embodiments thereof, given by way of non-limiting examples, in which:

FIG. 1a shows a top plan view of a disc brake according to an embodiment of the present invention;

FIG. 1b shows a section view of the brake disc in FIG. 1 taken along the section plane A-A indicated thereon;

FIG. 2a shows FIG. 1b with some parts illustrated out of proportion for illustration needs;

FIG. 2b shows FIG. 1b with some parts illustrated out of proportion for illustration needs in relation to an embodiment of the invention alternative to that illustrated in FIG. 2a;

FIG. 3a shows a picture of a brake disc with a black or blackish braking band, made according to the present invention;

FIG. 3b shows an enlarged detail of the picture in FIG. 3a;

FIG. 4a shows a picture of a brake disc similar to that shown in the picture in FIG. 2, but with a conventional braking band having the colour of stainless steel; and

FIG. 4b shows an enlarged detail of the picture in FIG. 4a.

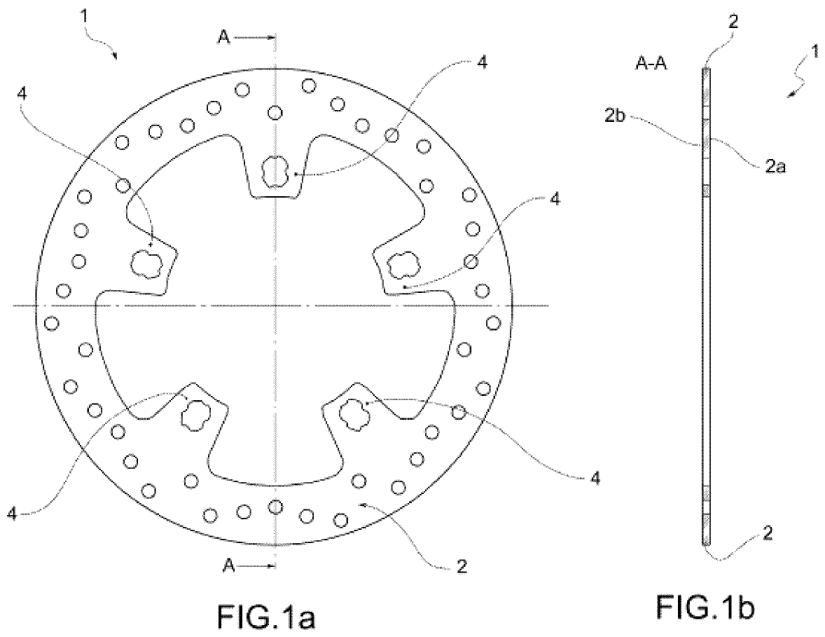

Elements or parts of elements common to the embodiments described below will be indicated using the same reference numerals.

### DETAILED DESCRIPTION

With reference to the aforesaid figures, reference numeral 1 indicates as a whole a brake disc according to the present invention.

According to a general constructional solution of the invention, shown in the accompanying figures, the disc brake 1 comprises a braking band 2, provided with two opposite braking surfaces 2a and 2b, each of which at least partially defines one of the two main faces of the disc 1.

In particular, the brake disc 1 can be of the ventilated type.

Advantageously, the brake disc 1 can be provided with a portion adapted to fix the disc to a vehicle.

Generally, if the brake disc is for motorcycles, the fixing portion is a wheel hub connection element referred as a bell. Alternatively, as shown in the accompanying figures, the fixing portion can consist of either a plurality of appendages 4 radially extending into the braking band by connecting directly to the wheel hub or a plurality of appendages radially extending outside the braking band by connecting to the outermost portion of the rim (peripheral brake disc).

Generally, if the brake disc is for motor vehicles, the fixing portion is a wheel hub connection element referred to as a bell. Alternatively, the fixing portion can consist of a plurality of appendages radially extending outside the braking band by connecting to the outermost portion of the rim (peripheral brake disc).

The bell in a brake disc for motorcycles or motor vehicles (if provided) can be made in one piece with the braking band or be made separately and then fixed to the braking band by means of appropriate connecting elements or by means of other technological processes (i.e., co-casting).

The fixing portion of a brake disc for motorcycles or motor vehicles (whether it consists of a bell or pluralities of appendages) can be made of the same material as the braking band, such as steel or grey cast iron, or of another suitable material, such as aluminium alloy. In particular, the entire disc (i.e., the braking band and the fixing portion) can be made of stainless steel.

The braking band 2 is made by casting. Similarly, the fixing portion and/or the bell can be made by casting.

Preferably, if the brake disc is for motorcycles, the braking band with the fixing portion thereof is made by blanking.

Preferably, if the brake disc is for motor vehicles, the braking band and the bell can both be obtained by casting; or the braking band can be obtained by blanking and the bell by casting; or the braking band can be obtained by casting and the bell by deep drawing.

The fixing portion can be made in a single body with the braking band (as shown in the accompanying figures) or can be made as a separate body, mechanically connected to the braking band.

The braking band 2 is made of grey cast iron or steel, preferably stainless steel.

According to the preferred embodiment shown in the accompanying figures, the brake disc 1 is a brake disc for motorcycles. However, the brake disc 1 can also be a brake disc for motor vehicles.

The disc 1 comprises a surface coating 3 covering at least one of the two braking surfaces of the braking band.

According to the invention, the aforesaid surface coating 3 is based on a mixture of one or more aluminium oxides and one or more titanium oxides. Such a surface coating 3 has a darker colour than that of the steel of the braking band 2.

Preferably, the aforesaid surface coating 3 consists of:
55% to 95% by weight of one or more aluminium oxides;
5% to 45% by weight of one or more titanium oxides; and
0% to 40% by weight of one or more oxides selected from the group consisting of manganese oxides, iron oxides, and nickel oxides. Preferably, said of one or more oxides, if provided, are selected from the group consisting of MnO, MnO₂, Mn₂O₃, FeO, Fe₃O₄ and Ni₂O₃.

The aforesaid surface coating 3 can consist of a mixture of one or more aluminium oxides and one or more titanium oxides.

In this case, the surface coating 3 preferably consists of 70% to 95% by weight of alumina (Al₂O₃) and the rest of titanium dioxide (TiO₂). Even more preferably, the surface coating 3 consists of 85% to 90% by weight of alumina (Al₂O₃) and the rest of titanium dioxide (TiO₂).

Alternatively, said surface coating 3 can comprise-in addition to said one or more aluminium oxides and said one or more titanium oxides-other metal oxides adapted to accentuate the black or blackish or otherwise darker colour of the starting substrate that already characterizes the surface coating 3 consisting only of a mixture of one or more aluminium oxides and one or more titanium oxides.

In this case, the aforesaid surface coating 3 preferably consists of:
55% to 85% by weight of one or more aluminium oxides;
10% to 40% by weight of one or more titanium oxides; and
5% to 35% by weight of one or more oxides selected from the group consisting of manganese oxides, iron oxides and nickel oxides. Preferably, said one or more oxides are selected from the group consisting of MnO, MnO₂, Mn₂O₃, FeO, Fe₃O₄ and Ni₂O₃.

According to a preferred embodiment, the aforesaid surface coating 3 consists of:
70% to 85% by weight of alumina (Al₂O₃);
10% to 25% by weight of titanium dioxide (TiO₂);
5% to 20% of one or more oxides selected from the group consisting of MnO, MnO₂, Mn₂O₃, FeO, Fe₃O₄ and Ni₂O₃.

In particular, the thickness of the surface coating 3 can be between 10 μm and 500 μm. Preferably, the thickness of the surface coating 3 is between 30 μm and 350 μm, and even more preferably between 50 μm and 250 μm. The choice of such a range of values allows achieving an optimum balance between the consumption of the protective coating layer and the limitation of the thermal expansions on the coating itself. In other words, if the thickness of the protective coating were less than 10 μm, in case of wear, it would be totally removed in a too short time. A thickness above 500 μm, on the other hand, could result in an imperfect adhesion over time, due to thermal expansions occurring during the life cycle of a disc brake.

Preferably, the surface coating 3 is a layer obtained by depositing the material in particulate form (e.g., powder), which will form the coating by means of one of the following deposition techniques: APS (Atmospheric Plasma Spray); HVOF (High-Velocity Oxygen Fuel); HVAF (High-Velocity Air Fuel); KM (Kinetic Metallisation); laser cladding (or Laser Metal Deposition, LMD); or cold spray.

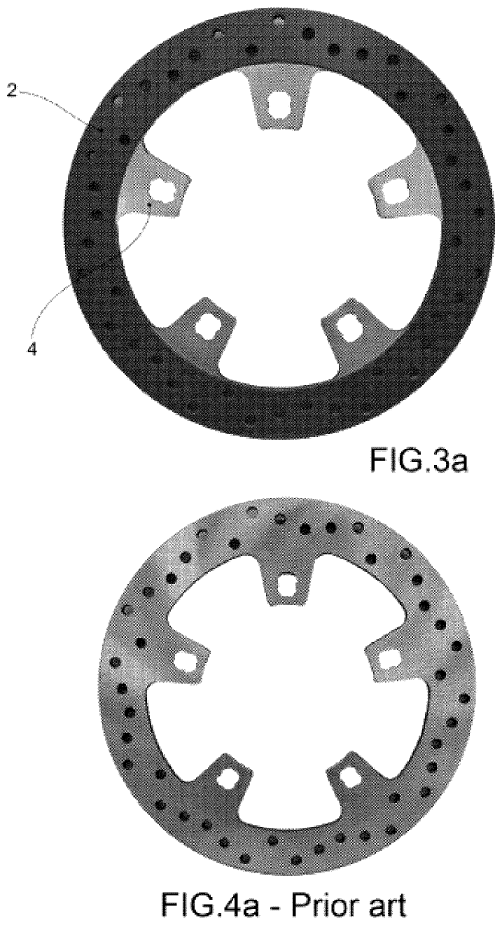

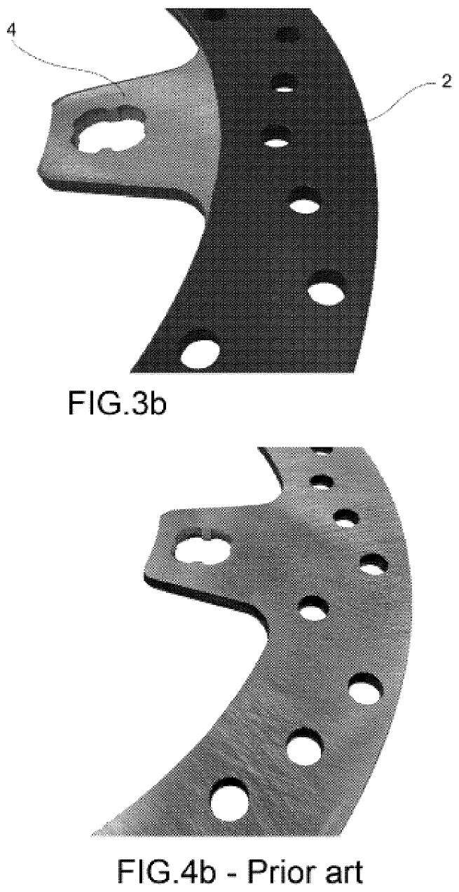

As apparent from a comparison between the pictures in FIGS. 3a and 3b and the pictures in FIGS. 4a and 4b, the aforesaid surface coating 3 has a darker colour than the stainless steel. In particular, the aforesaid surface coating 3 has a black or blackish or otherwise darker colour than the starting substrate. This can also be seen by observing only FIGS. 3a-b, considering the different colour of the coated braking band (black or blackish or otherwise darker than the starting substrate) and the uncoated fixing portion of the braking band (plurality of appendages 4).

This allows differentiating the colour of the braking band from the traditional colour of stainless steel or grey cast iron, thus meeting the market needs.

Moreover, it was possible to verify experimentally that the surface coating 3 has a micro-hardness between 1100 and 1300 HV₃₀₀.

Such hardness values are higher than hardness values of the order of 400 HV₃₀₀, which are typical of the hardened stainless steels normally used to make brake discs.

By virtue of such hardness values of the surface coating 3, the brake disc 1 according to the invention has a longer service life than a conventional brake disc made of hardened stainless steel without coating or made of grey cast iron without coating.

Moreover, it was also experimentally found that, compared with a conventional brake disc made of hardened stainless steel or grey cast iron, the brake disc 1 with a coated braking band according to the invention has:
greater resistance to wear and abrasion;
greater resistance to high temperatures;
greater corrosion resistance.

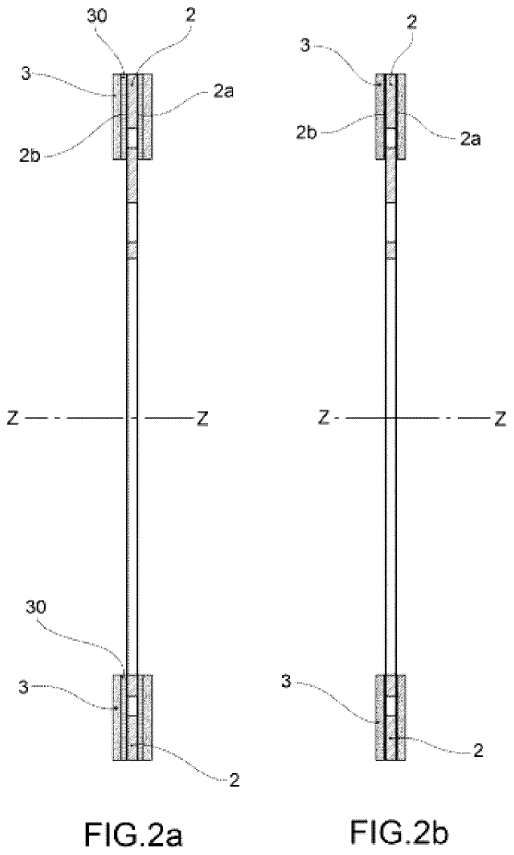

As diagrammatically shown in FIG. 2b, the surface coating 3 can be in direct contact with the braking surface of the braking band. In this case, the surface coating 3 is the only coating on the brake disc 1.

Alternatively, as diagrammatically shown in FIG. 2a, the brake disc 1 can comprise a base coating 30 arranged below the surface coating 3 and in direct contact with the braking surface of the braking band.

In this case, the brake disc 1 is provided with:
a base coating 30 covering at least one of the two braking surfaces of the braking band and is made in direct contact with such a surface; and
a surface coating 3 covering at least one of the two braking surfaces of the braking band and is made to cover the aforesaid base coating 30.

The aforesaid base coating 30 consists of nickel and/or nickel carbides, aluminium and/or aluminium oxides, or a mixture of nickel and/or nickel carbides and aluminium and/or aluminium oxides.

Preferably, the aforesaid base coating 30 consists of 75% to 95% by weight of nickel and/or nickel carbides and the rest of aluminium and/or aluminium oxides. Even more preferably, the aforesaid base coating 30 consists of 90% to 95% by weight of nickel and/or nickel carbides and the rest of aluminium and/or aluminium oxides.

Alternatively, the aforesaid base coating 30 can consist of 100% by weight of nickel and/or nickel carbides or 100% by weight of aluminium and/or aluminium oxides.

In particular, the base coating 30 has a thickness between 10 μm and 500 μm, preferably between 30 μm and 350 μm, and even more preferably between 50 μm and 150 μm.

Preferably, the base coating 30 is a layer obtained by depositing the material in particulate form (e.g., powder), which will form the coating by means of one of the following deposition techniques: APS (Atmospheric Plasma Spray); HVOF (High-Velocity Oxygen Fuel); HVAF (High-Velocity Air Fuel); KM (Kinetic Metallisation); laser cladding (or Laser Metal Deposition, LMD); or cold spray.

Advantageously, the base coating 30 performs a mechanical “anchoring” function for the surface coating 3, which has a colouring and anti-wear function instead. Indeed, the base coating 30 formed from nickel/nickel oxides and/or aluminium/aluminium oxides has an intermediate coefficient of thermal expansion between the base material (steel or grey cast iron) and the surface coating 3 formed from one or more aluminium oxides, one or more titanium oxides, and possibly manganese oxides, iron oxides, and nickel oxides. This gives base coating 30 the ability to dampen the differences in thermal expansion between the base material and the surface coating 3, thus reducing the risk of causing cracks and fissures in the protective surface coating 3.

As for the anti-wear and colouring function, the protective surface coating 3 is not affected by the presence of the protective base coating 30.

As mentioned above, the surface coating 3 and the base coating 30 (if provided) cover at least one of the two braking surfaces of the braking band.

Preferably, as shown in FIGS. 2a and 2b, the braking band 2 is coated at both the braking surfaces 2a and 2b thereof.

In particular, the surface coating 3 and the base coating 30, if provided, can cover only the braking band on a single braking surface or on both braking surfaces.

to embodiments not shown in the According accompanying figures, the surface coating 3 and the base coating 30, if provided, can also extend to other parts of the disc 1, such as the annular fixing portion 4 and the bell (is provided) to cover the entire surface of disc 1. In particular, the surface coating 3 and the base coating 30, if provided, can cover-in addition to the braking band-only the fixing portion or only the bell. The choice is dictated by essentially aesthetic reasons, to have an even colour and/or finishing on the entire disc or between some portions thereof.

One reason why it would be convenient to coat the entire brake disc 1 is to avoid corrosive/oxidative phenomena, especially related to the contact portion between bell and hub, which can make the assembly difficult or create malfunctions (change in flatness of the mating surfaces).

Advantageously, at least one portion of said at least one braking surface 2a or 2b covered by said surface coating 3 or base coating 30 (if provided) can consist of an activated surface having a rough profile. Such a rough profile is filled with the coating.

In particular, such a rough profile can be defined by one or more grooves or channels, each of which is delimited by at least one pair of protuberances.

Such an activated surface can be obtained by subjecting (before the deposition of the coating) the braking surface to a processing adapted to increase the surface roughness thereof by chip-removal machining or laser engraving or plastic deformation.

Operatively, the activated surface is functional to increase the adhesive capacity of the surface coating 3 deposited on the braking surface.

For simplicity of disclosure, the brake disc 1 will now be described along with the method according to the present invention. The brake disc 1 is preferably, but not necessarily, made by the method according to the invention described below.

According to a general implementation of the method according to the invention, the method comprises the following operating steps:
a) preparing a brake disc, comprising a braking band 2 provided with two opposite braking surfaces 2a, 2b, each of which at least partially defines one of the two main faces of the disc, the braking band being made of grey cast iron or steel, preferably stainless steel;
b) depositing on the brake disc a layer of particulate material based on a mixture of one or more aluminium oxides and one or more titanium oxides, forming a surface coating 3 covering at least one of the two braking surfaces of the braking band.

The aforesaid surface coating 3 has a darker colour than the steel of braking band 2.

Preferably, the particulate material deposited in the step b) of deposition to make the surface coating 3 consists of:
55% to 95% by weight of one or more aluminium oxides;
5% to 45% by weight of one or more titanium oxides; and
0% to 40% by weight of one or more oxides selected from the group consisting of manganese oxides, iron oxides, and nickel oxides.

Preferably, said of one or more oxides, if provided, are selected from the group consisting of MnO, MnO₂, Mn₂O₃, FeO, Fe₃O₄ and Ni₂O₃.

The particulate material deposited during step b) of deposition to make the surface coating 3 can consist of a mixture of one or more aluminium oxides and one or more titanium oxides.

In this case, the particulate material deposited in step b) preferably consists of 70% to 95% by weight of alumina Al₂O₃ and the rest of titanium dioxide TiO₂. Even more preferably, the particulate material deposited in step b) consists of 85% to 90% by weight of alumina A1₂O₃ and the rest of titanium dioxide TiO₂.

Alternatively, the particulate material deposited in step b) of deposition to make the surface coating 3 can comprise—in addition to said one or more aluminium oxides and said one or more titanium oxides—other metal oxides adapted to accentuate the black or blackish or otherwise darker colour of the starting substrate that already characterizes the surface coating 3 consisting only of a mixture of one or more aluminium oxides and one or more titanium oxides.

In this case, the particulate material deposited in step b) preferably consists of:
55% to 85% by weight of one or more aluminium oxides;
10% to 40% by weight of one or more titanium oxides; and
5% to 35% by weight of one or more oxides selected from the group consisting of manganese oxides, iron oxides and nickel oxides. Preferably, said one or more oxides are selected from the group consisting of MnO, MnO₂, Mn₂O₃, FeO, Fe₃O₄ and Ni₂O₃.

According to a preferred embodiment, the particulate material deposited in step b) consists of:
70% to 85% by weight of alumina (Al₂O₃);
10% to 25% by weight of titanium dioxide (TiO₂);
5% to 20% of one or more oxides selected from the group consisting of MnO, MnO₂, Mn₂O₃, FeO, Fe₃O₄ and Ni₂O₃.

Advantageously, the surface coating 3 obtained at the end of step b) of deposition has a black or blackish or otherwise darker colour than the starting substrate.

Advantageously, the surface coating 3 obtained at the end of step b) of deposition has a micro-hardness between 1100 and 1300 HV₃₀₀.

Preferably, step b) of deposition is carried out to obtain a thickness of the surface coating 3 between 10 μm and 500 μm, preferably between 30 μm and 350 μm, and even more preferably between 50 μm and 250 μm.

As mentioned above, the choice of such a range of values allows achieving an optimal balance between the consumption of the protective coating layer and the limitation of the thermal expansions on the coating itself. In other words, if the thickness of the protective coating were less than 10 μm, in case of wear, it would be totally removed in a too short time. A thickness above 500 μm, on the other hand, could result in an imperfect adhesion over time, due to thermal expansions occurring during the life cycle of a disc brake.

Preferably, the surface coating 3 is obtained by carrying out step b) by means of one of the following deposition techniques: APS (Atmospheric Plasma Spray); HVOF (High-Velocity Oxygen Fuel); HVAF (High-Velocity Air Fuel); KM (Kinetic Metallisation); laser cladding (or Laser Metal Deposition, LMD); or cold spray.

Advantageously, the material in particulate form deposited in step e) to form the surface coating 3 has a particle size between 5 and 40 μm. The choice of such a range of values allows giving the coating high features of density, hardness and limited porosity. The choice of such a range was made by balancing two opposing needs: porosity reduction and adhesion increase. Particles of smaller particle size (and therefore lower mass) create a less porous and more compact layer, but lower mass means lower kinetic energy during the step of depositing the coating, thus potentially lower adhesion.

The surface coating 3 can be obtained by depositing the particulate material in direct contact with the braking surface of the braking band.

Alternatively, the surface coating 3 can be obtained by depositing the particulate material not in direct contact with the braking surface of the braking band, but above a base coating 30, previously deposited on the braking surface of the braking band 2.

For this purpose, the method preferably comprises a step c) of depositing on the disc a layer of material in a particulate form consisting of nickel and/or nickel carbides, aluminium and/or aluminium oxides, or a mixture of nickel and/or nickel carbides and aluminium and/or aluminium oxides, forming a base coating 30 covering at least one of the two braking surfaces of the braking band in direct contact therewith.

Operatively, such a step (c) is then carried out before the aforesaid step b). The surface coating 3 is deposited above the base coating 30.

Preferably, the particulate material deposited in step c) of deposition to make the aforesaid base coating 30 consists of 75% to 95% by weight of nickel and/or nickel carbides and the rest of aluminium and/or aluminium oxides. Preferably, the particulate material deposited in step c) consists of 90% to 95% by weight of nickel and/or nickel carbides and the rest of aluminium and/or aluminium oxides.

Preferably, step c) of deposition is carried out to obtain a thickness of the base coating 30 between 10 μm and 500 μm, preferably between 30 μm and 350 μm, and even more preferably between 50 μm and 150 μm. Within such ranges of thicknesses, the base coating 30 allow to perform the aforementioned damper effect on thermal strain, which helps to preserve the integrity of the surface coating 3.

Preferably, the base coating 30 is obtained by performing step c) by means of one of the following deposition techniques: APS (Atmospheric Plasma Spray); HVOF (High-Velocity Oxygen Fuel); HVAF (High-Velocity Air Fuel); KM (Kinetic Metallisation); laser cladding (or Laser Metal Deposition, LMD); or cold spray.

Advantageously, the material in particulate form deposited in step d) to form the base coating 30 has a particle size between 5 and 40 μm. The choice of such a range of values allows giving the coating high features of density and capacity of adhesion to the deposition surface. The choice of such a range was made by balancing two opposing needs: porosity reduction and adhesion increase. Particles of smaller particle size (and therefore lower mass) create a less porous and more compact layer, but lower mass means lower kinetic energy during the deposition process and thus potentially lower adhesion.

Preferably, both step b) of deposition and the possible step c) of deposition are carried out at an average temperature of deposition on the component not exceeding 250° C.

Preferably, the method comprises a step d) of preparing the surface on which the base coating 30 (if provided) and the surface coating 3 are to be made. Such a step d) must thus be carried out before carrying out step b) or step c), if included.

In particular, step d) of surface preparation can comprise a sub-step d1) of cleaning the surface with solvents adapted to remove oil or dirt.

Preferably, step d) of preparation can comprise a sub-step d2) of subjecting at least one portion of said at least one braking surface 2a or 2b to a processing adapted to increase the surface roughness thereof by chip-removal machining or laser engraving or plastic deformation, thus forming an activated portion of said braking surface.

Operatively, such a sub-step d2) is functional to increase the adhesive capacity of the base coating 30 (if provided) or the surface coating 3 deposited on the braking surface.

In particular, such a sub-step d2) is functional to make a rough profile on the braking surface, which can be defined by one or more grooves or channels, each of which is delimited by at least one pair of protuberances.

Advantageously, the method can comprise a step e) of surface finishing of the aforesaid surface coating, e.g., by mechanical machining (grinding, turning, brushing, etc.).

In particular, such a surface finish of the coated disc is useful in order to return it to the correct geometric and dimensional operating tolerances, possibly lost during the deposition processes b) and c), and in order to ensure a proper surface roughness aimed at optimizing the tribological contact with the friction elements.

As can be appreciated from the above description, the brake disc according to the invention allows overcoming the drawbacks of the prior art.

The brake disc 1 according to the invention, by virtue of the surface coating 3, has a darker colour than steel or grey cast iron. In particular, the aforesaid surface coating 3 has a black or blackish or otherwise darker colour than the starting substrate. This allows differentiating the colour of the braking band from the traditional colour of stainless steel or grey cast iron, thus meeting the market needs.

The brake disc 1 according to the invention, by virtue of the surface coating 3 covering at least one of the two braking surfaces of the band, has a longer service life than a conventional brake disc made of hardened stainless steel without coating.

Compared with a conventional brake disc made of hardened stainless steel or grey cast iron, the brake disc 1 with coated braking band according to the invention has:
a black or blackish or otherwise darker colour of the starting substrate at the braking band, at least in the coated surface;
greater resistance to wear and abrasion resulting in reduced dust emission;
greater resistance to high temperatures;
greater corrosion resistance, which ensures more stable working conditions over time.

The surface coating 3 also acts as a thermal barrier for the underlying braking band, by virtue of the lower thermal conductivity of the materials used for the coating compared to steel or grey cast iron.

By virtue of the invention, it is possible to make brake discs made of steel or grey cast iron, having a black or blackish or otherwise darker colour than the starting substrate, at significantly lower costs when compared to brake discs with a black or blackish or otherwise darker colour than the starting substrate currently available on the market, made of carbon alone or carbon ceramic materials.

In order to meet contingent specific needs, those skilled in the art may make several changes and variations to the method and brake disc described above, all contained within the scope of the invention defined by the following claims.

1-35. (canceled)

36. Brake disc for disc brake, in particular for motor cycles or motor vehicles, comprising a braking band (2), provided with two opposite braking surfaces (2a, 2b), each of which at least partially defines one of the two main faces of the disc (1), the braking band (2) being made of grey cast iron or steel, preferably stainless steel, said disc comprising a surface coating (3) covering at least one of the two braking surfaces of the braking band,
characterised in that said surface coating (3) is based on a mixture of one or more aluminium oxides and one or more titanium oxides, said surface coating (3) having a darker colour with respect to the steel or grey cast iron of the braking band (2).

37. Disc according to claim 36, wherein said surface coating (3) consists of:
55% to 95% by weight of one or more aluminium oxides;
5% to 45% by weight of one or more titanium oxides; and
0% to 40% by weight of one or more oxides selected from the group consisting of manganese oxides, iron oxides and nickel oxides, preferably MnO, MnO₂, Mn₂O₃, FeO, Fe₃O₄ and Ni₂O₃.

38. Disc according to claim 36, wherein said surface coating (3) consists only of a mixture of one or more aluminium oxides and one or more titanium oxides.

39. Disc according to claim 38, wherein said surface coating (3) consists of 70% to 95% by weight of alumina (Al₂O₃) and the remaining of titanium dioxide (TiO₂), preferably 85% to 90% by weight of alumina (Al₂O₃) and the remaining of titanium dioxide (TiO₂).

40. Disc according to claim 36, wherein said surface coating (3) consists of:
55% to 85% by weight of one or more aluminium oxides;
10% to 40% by weight of one or more titanium oxides; and
5% to 35% by weight of one or more oxides selected from the group consisting of manganese oxides, iron oxides and nickel oxides, preferably MnO₂, Fe₃O₄ and Ni₂O₃.

41. Disc according to claim 40, wherein said surface coating (3) consists of:
70% to 85% by weight of alumina (Al₂O₃);
10% to 25% by weight of titanium dioxide (TiO₂);
5% to 20% of one or more oxides selected from the group consisting of MnO, MnO₂, Mn₂O₃, FeO, Fe₃O₄ and Ni₂O₃.

42. Disc according to claim 36, wherein said surface coating (3) has a black or blackish or in any case darker colour than the starting substrate.

43. Disc according to claim 36, wherein said surface coating (3) has a micro-hardness between 1100 and 1300 HV₃₀₀.

44. Disc according to claim 36, wherein the surface coating (3) has a thickness between 10 μm and 500 μm, and preferably between 30 μm and 350 μm, and even more preferably between 50 μm and 250 μm.

45. Disc according to claim 36, wherein the surface coating (3) is a layer obtained by the deposition technique APS (Atmospheric Plasma Spray), HVOF (High Velocity Oxygen Fuel), HVAF ((High Velocity Air Fuel), KM (Kinetic Metallization), laser cladding or cold spray.

46. Disc according to claim 36, wherein the surface coating (3) is in contact with the braking surface of the braking band.

47. Disc according to claim 36, comprising a base coating (30) which is arranged below said surface coating (3) and is in direct contact with the braking surface of the braking band, said base coating (30) consisting of nickel and/or nickel carbides and/or aluminium and/or aluminium oxides.

48. Disc according to claim 47, wherein the base coating (30) consists of 75% to 95% by weight of nickel and/or nickel carbides and the remaining of aluminium and/or aluminium oxides, preferably 90% to 95% by weight of nickel and/or nickel carbides and the remaining of aluminium and/or aluminium oxides.

49. Disc according to claim 47, wherein the base coating (30) consists of 100% by weight of nickel and/or nickel carbides or 100% by weight of aluminium and/or aluminium oxides

50. Disc according to claim 47, wherein the base coating (30) has a thickness between 10 μm and 500 μm, and preferably between 30 μm and 350 μm, and even more preferably between 50 μm and 150 μm.

51. Disc according to claim 47, wherein the base coating (30) is a layer obtained by the deposition technique APS (Atmospheric Plasma Spray), HVOF (High Velocity Oxygen Fuel), HVAF ((High Velocity Air Fuel), KM (Kinetic Metallization), laser cladding or cold spray.

52. Disc according to claim 36, wherein said brake disc is a brake disc for motorcycles.

53. Method for making a brake disc for disc brakes, in particular for motorcycles, comprising the following operating steps:
a) preparing a brake disc, comprising a braking band (2) provided with two opposite braking surfaces (2a, 2b), each of which at least partially defines one of the two main faces of the disc, the braking band being made of grey cast iron or steel, preferably stainless steel;
b) depositing on the brake disc a layer of particulate material based on a mixture of one or more aluminium oxides and one or more titanium oxides, forming a surface coating (3) covering at least one of the two braking surfaces of the braking band, said surface coating (3) having a darker colour with respect to the steel of the braking band (2).

54. Method according to claim 53, wherein the particulate material forming said surface coating (3) consists of:
55% to 95% by weight of one or more aluminium oxides;
5% to 45% by weight of one or more titanium oxides; and
0% to 40% by weight of one or more oxides selected from the group consisting of manganese oxides, iron oxides and nickel oxides, preferably MnO, MnO₂, Mn₂O₃, FeO, Fe₃O₄ and Ni₂O₃.

55. Method according to claim 53, wherein said particulate material forming said surface coating (3) consists only of a mixture of one or more aluminium oxides and one or more titanium oxides.

56. Method according to claim 55, wherein said particulate material deposited in the deposition step b) to make the surface coating (3) consists of 70% to 95% by weight of alumina (Al₂O₃) and the remaining of titanium dioxide (TiO₂), preferably 85% to 90% by weight of alumina (Al₂O₃) and the remaining of titanium dioxide (TiO₂).

57. Method according to claim 53, wherein the particulate material deposited in the deposition step b) to make the surface coating (3) consists of:
55% to 85% by weight of one or more aluminium oxides;
10% to 40% by weight of one or more titanium oxides; and
5% to 35% by weight of one or more oxides selected from the group consisting of manganese oxides, iron oxides and nickel oxides, preferably MnO, MnO₂, Mn₂O₃, FeO, Fe₃O₄ and Ni₂O₃.

58. Method according to claim 57, wherein the particulate material deposited in the deposition step b) to make the surface coating (3) consists of:
70% to 85% by weight of alumina (Al₂O₃),
10% to 25% by weight of titanium dioxide (TiO₂);
5% to 20% of one or more oxides selected from the group consisting of MnO, MnO₂, Mn₂O₃, FeO, Fe₃O₄ and Ni₂O₃.

59. Method according to claim 53, wherein said surface coating (3) has a black or blackish or in any case darker colour than the starting substrate.

60. Method according to claim 53, wherein said surface coating (3) has a micro-hardness between 1100 and 1300 HV₃₀₀.

61. Method according to claim 53, wherein the surface coating (3) has a thickness between 10 μm and 500 μm, and preferably between 30 μm and 350 μm, and even more preferably between 50 μm and 250 μm.

62. Method according to claim 53, wherein the surface coating (3) is obtained by the deposition technique APS (Atmospheric Plasma Spray), HVOF (High Velocity Oxygen Fuel), HVAF ((High Velocity Air Fuel), KM (Kinetic Metallization), laser cladding or cold spray.

63. Method according to claim 53, wherein the surface coating (3) is obtained by depositing the particulate material in direct contact with the braking surface of the braking band.

64. Method according to claim 53, comprising a step c) of depositing on the disc a layer of particulate material consisting of nickel and/or nickel carbides and/or aluminium and/or aluminium oxides, forming a base coating (30) covering at least one of the two braking surfaces of the braking band in direct contact therewith, wherein said step c) being conducted before said step b), said surface coating (3) being formed above said base coating (30).

65. Method according to claim 64, wherein the particulate material deposited in the deposition step c) to make the base coating (30) consists of 75% to 95% by weight of nickel and/or nickel carbides and the remaining of aluminium and/or aluminium oxides, preferably 90% to 95% by weight of nickel and/or nickel carbides and the remaining of aluminium and/or aluminium oxides.

66. Method according to claim 64, wherein the particulate material deposited in the deposition step c) to make the base coating (30) consists of 100% by weight of nickel and/or nickel carbides or 100% by weight of aluminium and/or aluminium oxides.

67. Method according to claim 64, wherein the base coating (30) has a thickness between 10 μm and 500 μm, and preferably between 30 μm and 350 μm, and even more preferably between 50 μm and 150 μm.

68. Method according to claim 64, wherein the base coating (30) is obtained by the deposition technique APS (Atmospheric Plasma Spray), HVOF (High Velocity Oxygen Fuel), HVAF ((High Velocity Air Fuel), KM (Kinetic Metallization), laser cladding or cold spray.

69. Method according to claim 64, comprising a step d) of preparing the disc surface (1) before carrying out step b) or step c) if envisaged.

70. Method according to claim 64, comprising a step e) of surface finishing said surface coating (3).
